(19) United States
(12) Patent Application Publication
(10) Pub. No.: US 2026/0220406 A1
(43) Pub. Date: Jul. 30, 2026

(54) ENCODING METHOD AND DECODING METHOD, ENCODING SYSTEM AND DECODING SYSTEM FOR CIRCULAR TWO-DIMENSIONAL BAR CODE, COMPUTER DEVICE AND COMPUTER-READABLE STORAGE MEDIUM

(71) Applicant: SHANGHAI BILIBILI TECHNOLOGY CO., LTD., Yangpu District, Shanghai (CN)

(72) Inventors: Yang Weng, Yangpu District, Shanghai (CN); Weihua ZHANG, Yangpu District, Shanghai (CN)

(21) Appl. No.: 19/134,651

(22) PCT Filed: Jul. 6, 2023
(86) PCT No.: PCT/CN2023/106155

§ 371 Date: May 30, 2025

(30) Foreign Application Priority Data
Nov. 30, 2022 (CN) 202211533389.7

(51) Int. Cl. G06K 7/14; G06K 19/06

(52) U.S. Cl. CPC G06K 7/1417; G06K 19/06037

(57) ABSTRACT

The application discloses an encoding method for a circular two-dimensional bar code, including: converting data to be encoded into binary data; determining a two-dimensional bar code version of a two-dimensional bar code to be generated, where the two-dimensional bar code to be generated includes a plurality of rings corresponding to a same center, and each ring is corresponding to a plurality of data bits; determining a plurality of valid data bits of the plurality of rings according to the two-dimensional bar code version; dividing the plurality of valid data bits into a plurality of data segments; and generating corresponding code element patterns at the plurality of valid data bits according to the metadata and the binary data, so as to obtain the circular two-dimensional bar code. The circular two-dimensional bar code provided in the application requires specific encoding and decoding modes, has secure data content, and is applicable to dedicated use in a specific scenario.

The application claims priority to Chinese Patent Application No. 202211533389.7, filed on Nov. 30, 2022 and entitled “ENCODING METHOD AND DECODING METHOD FOR CIRCULAR TWO-DIMENSIONAL BAR CODE”, which is incorporated herein by reference in its entirety.

### TECHNICAL FIELD

Embodiments of the application relate to the field of computer technologies, and in particular, to an encoding method and a decoding method for a circular two-dimensional bar code, an encoding system and a decoding system therefor, a computer device, and a computer-readable storage medium.

### BACKGROUND

With the development of computer technologies, a two-dimensional bar code has become a convenient carrier for information transmission, and an integration degree of the two-dimensional bar code is increasingly high. A user can obtain related information or link to a related web page or interface by scanning the two-dimensional bar code. Encoding and decoding of the two-dimensional bar code is to complete conversion from binary to target data by using an established rule after a binary operation is performed on a picture. Common two-dimensional bar codes include a QR code, a WeChat mini program code, a TikTok code, and the like. The QR code, mini program code, and TikTok code are all closed-source two-dimensional bar codes, and cannot be directly used in other products.

Currently, a common two-dimensional bar code on the market is the QR code, and an open-source encoding and decoding design of the QR code has objectively led to an explosive growth in the quantity of QR code applications. The inventors recognize that, an open-source nature of a QR code generation algorithm leads to non-exclusivity of a QR code generation channel, that is, different subjects may generate a same two-dimensional bar code by using an open-source code, which thus poses a great risk to an application that needs to strictly limit a digital generation subject or scope, and privacy of data content is poor.

It should be noted that the foregoing content is not necessarily in the conventional technology, and is not used to limit the patent protection scope of the application.

### SUMMARY

An objective of embodiments of the application is to provide an encoding method and a decoding method for a circular two-dimensional bar code, an encoding system and a decoding system therefor, a computer device, and a computer-readable storage medium, so as to resolve the foregoing problem.

An aspect of the embodiments of the application provides an encoding method for a circular two-dimensional bar code, including:
converting data to be encoded into binary data;
determining a two-dimensional bar code version of a two-dimensional bar code to be generated, where the two-dimensional bar code to be generated includes a plurality of rings corresponding to a same center, and each ring is corresponding to a plurality of data bits;
determining a plurality of valid data bits of the plurality of rings according to the two-dimensional bar code version;
dividing the plurality of valid data bits into a plurality of data segments, where the plurality of data segments include a reserved field and a content data segment, the reserved field is used to encode metadata, and the content data segment is used to encode the binary data; and
generating corresponding code element patterns at the plurality of valid data bits according to the metadata and the binary data, so as to obtain the circular two-dimensional bar code.

Optionally, the determining a two-dimensional bar code version of a two-dimensional bar code to be generated includes:
determining the two-dimensional bar code version based on an information quantity of the data to be encoded;
wherein different two-dimensional bar code versions are corresponding to a plurality of valid data bits with different quantities.

Optionally, the encoding method further includes:
combining valid data bits of a single ring into one data segment based on a preset clock direction, so as to obtain a plurality of data segments of the plurality of rings.

Optionally, the encoding method further includes:
determining a sequence of the plurality of data segments according to a sequence from an innermost ring to an outermost ring of the plurality of rings.

Optionally, the encoding method further includes:
configuring a plurality of locators on an edge of the two-dimensional bar code to be generated, where the plurality of locators are distributed on the outermost ring of the plurality of rings.

Optionally, the method further includes:
determining data bits occupied by the plurality of locators as invalid data bits, where the invalid data bits are not used to load information.

Optionally, the method further includes:
generating a target pattern within the innermost ring of the plurality of rings, where the target pattern includes an identity.

An aspect of the embodiments of the application further provides an encoding system for a circular two-dimensional bar code, including:
a conversion module, configured to convert data to be encoded into binary data;
a first determining module, configured to determine a two-dimensional bar code version of a two-dimensional bar code to be generated, wherein the two-dimensional bar code to be generated includes a plurality of rings corresponding to a same center, and each ring is corresponding to a plurality of data bits;
a second determining module, configured to determine a plurality of valid data bits of the plurality of rings according to the two-dimensional bar code version;
a division module, configured to divide the plurality of valid data bits into a plurality of data segments, wherein the plurality of data segments include a reserved field and a content data segment, the reserved field is used to encode metadata, and the content data segment is used to encode the binary data; and
a generation module, configured to generate corresponding code element patterns at the plurality of valid data bits according to the metadata and the binary data, so as to obtain the circular two-dimensional bar code.

An aspect of the embodiments of the application further provides a decoding method for a circular two-dimensional bar code, including:
obtaining a circular two-dimensional bar code, wherein the circular two-dimensional bar code includes a plurality of rings, the plurality of rings are corresponding to a same center, and each ring is corresponding to a plurality of data bits;
determining a plurality of valid data bits of the plurality of rings according to a two-dimensional bar code version, wherein the plurality of valid data bits are divided into a plurality of data segments, the plurality of data segments include a reserved field and a content data segment, the reserved field is used to store metadata, and the content data segment is used to store binary data; and
obtaining binary data of the circular two-dimensional bar code according to a plurality of valid code element patterns corresponding to the plurality of valid data bits.

Optionally, the decoding method further includes:
determining valid data bits of a single ring as one data segment based on a preset clock direction, so as to obtain a plurality of data segments of the plurality of rings; and
determining a sequence of the plurality of data segments according to a sequence from an innermost ring to an outermost ring of the plurality of rings.

An aspect of the embodiments of the application further provides a decoding system for a circular two-dimensional bar code, including:
a first obtaining module, configured to obtain a circular two-dimensional bar code, where the circular two-dimensional bar code includes a plurality of rings, the plurality of rings are corresponding to a same center, and each ring is corresponding to a plurality of data bits;
a determining module, configured to determine a plurality of valid data bits of the plurality of rings according to a two-dimensional bar code version, where the plurality of valid data bits are divided into a plurality of data segments, the plurality of data segments include a reserved field and a content data segment, the reserved field is used to store metadata, and the content data segment is used to store binary data; and
a second obtaining module, configured to obtain binary data of the circular two-dimensional bar code according to a plurality of valid code element patterns corresponding to the plurality of valid data bits.

An aspect of the embodiments of the application further provides a computer device, including a memory, a processor, and computer-readable instructions that are stored in the memory and that are capable of running on the processor, wherein when executing the computer-readable instructions, the processor implements steps of the encoding method and/or the decoding method for a circular two-dimensional bar code as described above.

An aspect of the embodiments of the application further provides a computer-readable storage medium, storing computer-readable instructions. The computer-readable instructions are capable of being executed by at least one processor to enable the at least one processor to perform steps of the encoding method and/or the decoding method for a circular two-dimensional bar code as described above.

The encoding and decoding modes, the encoding and decoding systems, the computer device, and the computer-readable storage medium, which are provided in the embodiments of the application, may include the following technical effects:

Different from a case in which black and white code elements are used as valid encoded data of a two-dimensional bar code, in the embodiment, valid encoded data on each ring is determined by first determining valid data bits and invalid data bits. Therefore, the circular two-dimensional bar code requires specific encoding and decoding modes. In the context of privacy and showcasing brand personality, a highly recognizable and private special-shaped (circular) two-dimensional bar code is provided, which has secure data content, and is applicable to dedicated use in a specific scenario.

### BRIEF DESCRIPTION OF DRAWINGS

FIG. 1 is a schematic diagram of an application environment of an encoding method for a circular two-dimensional bar code according to an embodiment of the application;

FIG. 2 is a schematic flowchart of an encoding method for a circular two-dimensional bar code according to Embodiment 1 of the application.

FIG. 3 schematically shows an example pattern of a circular two-dimensional bar code according to Embodiment 1 of the application;

FIG. 4 schematically shows a reserved field;

FIG. 5 schematically shows another example pattern of a circular two-dimensional bar code according to Embodiment 1 of the application;

FIG. 6 schematically shows another example pattern of a circular two-dimensional bar code according to Embodiment 1 of the application;

FIG. 7 schematically shows an encoding sequence of a circular two-dimensional bar code according to Embodiment 1 of the application;

FIG. 8 is a schematic flowchart of an encoding method for a circular two-dimensional bar code according to Embodiment 2 of the application;

FIG. 9 is a schematic block diagram of an encoding system for a circular two-dimensional bar code according to Embodiment 3 of the application;

FIG. 10 is a schematic block diagram of a decoding system for a circular two-dimensional bar code according to Embodiment 4 of the application; and

FIG. 11 is a schematic diagram of a hardware architecture of a computer device suitable for implementing an encoding/decoding method for a circular two-dimensional bar code according to Embodiment 5 of the application.

### DESCRIPTION OF EMBODIMENTS

To make the objectives, technical solutions, and advantages of the application clearer and more comprehensible, the following further describes the application in detail with reference to the accompanying drawings and embodiments. It should be understood that the specific embodiments described herein are merely used to explain the application but are not intended to limit the application. All other embodiments obtained by a person of ordinary skill in the art based on the embodiments of the application without creative efforts shall fall within the protection scope of the application.

It should be noted that the descriptions such as “first” and “second” in the embodiments of the application are merely used for description, and shall not be understood as an indication or implication of relative importance or an implicit indication of a quantity of indicated technical features. Therefore, a feature defined with “first” or “second” may explicitly or implicitly include at least one feature. In addition, the technical solutions in the embodiments of the application may be combined with each other, provided that a person of ordinary skill in the art can implement the combination. When the combination of the technical solutions is contradictory or cannot be implemented, it should be considered that the combination of the technical solutions does not exist and does not fall within the protection scope of the application.

In the descriptions of the application, it should be understood that numerical symbols before steps do not indicate an order of performing the steps, but are merely used to facilitate description of the application and differentiation of each step, and therefore cannot be construed as a limitation on the application.

The following provides an explanation of the terms in the application.

A two-dimensional bar code (2-Dimensional Bar Code) is a black and white graphic that records data symbol information and is distributed in a plane (a two-dimensional direction) according to a certain pattern by using certain geometric shapes.

Binarization refers to a technology of converting an entire picture into a visual effect with only two colors, black and white, by an image algorithm.

Error correcting code (ECC) is a technology that can detect and correct errors, improving stability and reliability of operation.

Perspective transformation is a technology that projects a picture to a new perspective or plane and can convert the transformed perspective into a plane effect.

To help a person skilled in the art understand the technical solutions provided in the embodiments of the application, the following describes related technologies.

With the development of computer technologies, a two-dimensional bar code has become a convenient carrier for information transmission, and an integration degree of the two-dimensional bar code is increasingly high. A user can obtain related information or link to a related web page or interface by scanning the two-dimensional bar code. Encoding and decoding of the two-dimensional bar code is to complete conversion from binary to target data by using an established rule after a binary operation is performed on a picture. There are many types of two-dimensional bar codes. Two-dimensional bar codes with different code systems have different structures, and writing and reading methods, such as a PDF417 code, a QR code, a Hanxin code, a color bar code, a quick mark code, a data matrix, and so on. Common two-dimensional bar codes include a QR code, a WeChat mini program code, a TikTok code, and the like. The mini program code and the TikTok code are closed-source two-dimensional bar codes, and cannot be directly used in other products.

Original information may be scanned and parsed by a two-dimensional bar code reading device. For example, a paper two-dimensional bar code and an electronic two-dimensional bar code can be scanned. Therefore, the two-dimensional bar code can be applied to fields such as electronic ticketing, electronic coupons, membership systems, and account login verification.

The following further describes a two-dimensional bar code-related technology by using a Quick Response Code (QR code) as an example.

The QR code may use four normalized coding modes (numbers, alphanumeric numbers, bytes, and Chinese characters) to store data. Because the QR code can store more data, provide an open-source encoding and decoding design, and has a good recognition rate, an application range of the QR code may be extended to more scenarios. However, the QR code is not applicable in a scenario in which privacy of data content is required, for example, in a scenario in which parsing of two-dimensional bar code content is desired to be accomplished only in specific APPs.

In view of this, embodiments of the application provide a new two-dimensional bar code solution, which can implement data content security and is applicable to a specific scenario. The two-dimensional bar code solution has a high recognition success rate in the context of privacy and showcasing brand personality.

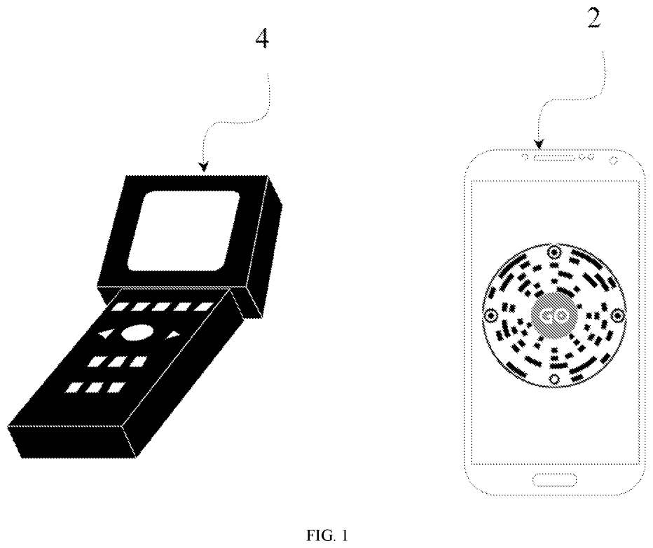

The following provides an example application environment of the application. For example, the application may be applied to an encoding device 2 for a two-dimensional bar code and a decoding device 4 for a two-dimensional bar code that are shown in FIG. 1.

The encoding device 2 for a two-dimensional bar code may be any setup that carries functions of generating and/or parsing a two-dimensional bar code, for example, a smartphone, a tablet computer, a laptop computer, a workstation, a game device, a digital streaming device, a vehicle user terminal, a smart television, or a set-top box, or may be a virtualized computing instance in a server. The virtualized computing instance may include a simulation of a virtual machine such as a computer system, an operating system, or a server.

The encoding device 2 for a two-dimensional bar code may include a plurality of client programs, such as a generator for a two-dimensional bar code or a recognizer for a two-dimensional bar code. The generator for a two-dimensional bar code may provide a function of generating a two-dimensional bar code, and the recognizer for a two-dimensional bar code is configured to provide a function of parsing a two-dimensional bar code.

The decoding device 4 for a two-dimensional bar code may be a specific scanning device, or may be a general-purpose device that carries scanning and recognition functions, such as a smartphone.

The following provides a plurality of embodiments in the foregoing example application environment, so as to describe the technical solutions of the embodiments of the application. The encoding device 2 for a two-dimensional bar code or the decoding device 4 for a two-dimensional bar code may serve as an execution body of encoding and decoding of a circular two-dimensional bar code.

### Embodiment 1

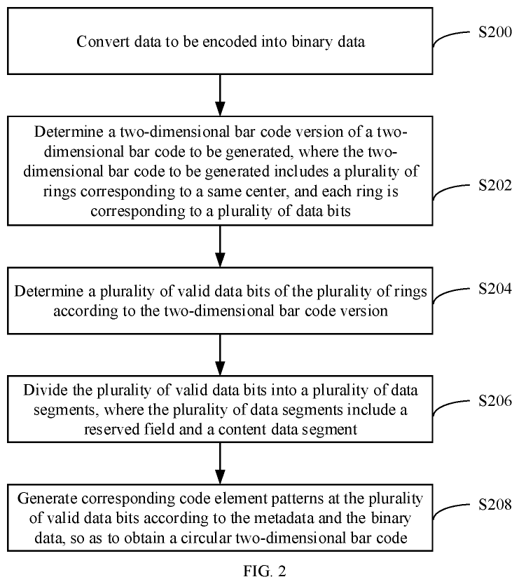

FIG. 2 is a schematic flowchart of an encoding method for a circular two-dimensional bar code according to Embodiment 1 of the application. As shown in FIG. 2, the encoding method for a circular two-dimensional bar code may include steps S200 to S210.
Step S200: Convert data to be encoded into binary data.
Step S202: Determine a two-dimensional bar code version of a two-dimensional bar code to be generated, wherein the two-dimensional bar code to be generated includes a plurality of rings corresponding to a same center, and each ring is corresponding to a plurality of data bits.
Step S204: Determine a plurality of valid data bits of the plurality of rings according to the two-dimensional bar code version.
Step S206: Divide the plurality of valid data bits into a plurality of data segments, wherein the plurality of data segments include a reserved field and a content data segment, the reserved field is used to encode metadata, and the content data segment is used to encode the binary data.
Step S208: Generate corresponding code element patterns at the plurality of valid data bits according to the metadata and the binary data, so as to obtain the circular two-dimensional bar code.

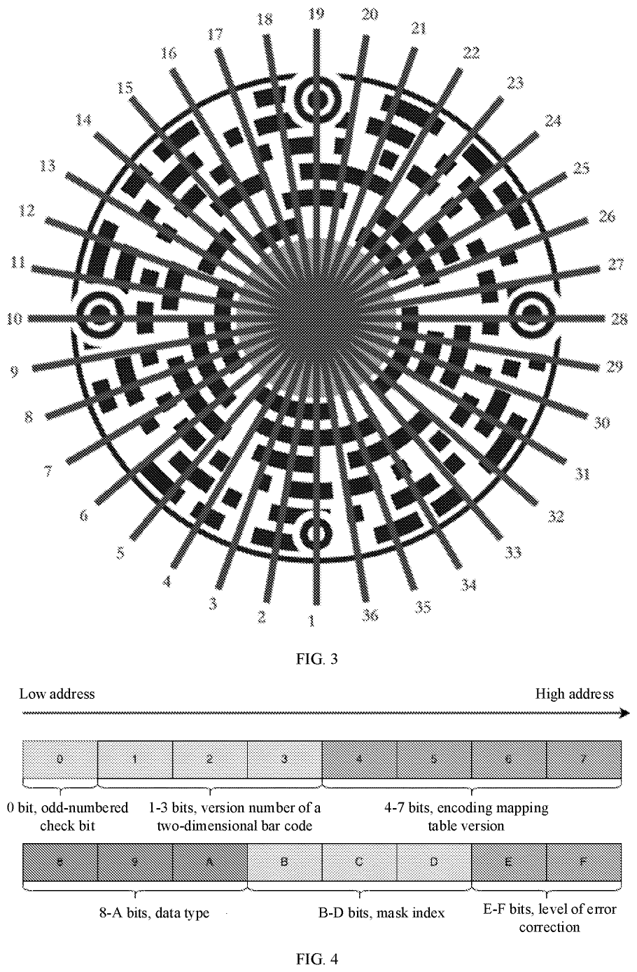

FIG. 3 is used as an example in which the circular two-dimensional bar code has six rings from inside to outside. Each ring has a different size, and there is a spacing between adjacent rings to prevent overlapping and intersection. To ensure effective recognition efficiency, a shape of the ring may be a circle shown in FIG. 2. The plurality of rings are concentric rings, and a center point of each ring is a dot. It should be noted that the shape of the ring may alternatively be an elliptic ring, a rectangular ring, a triangular ring, or the like, and is designed according to an actual requirement.

The ring is formed by alternately combining a plurality of first code element patterns and a plurality of second code element patterns.

A third ring in FIG. 3 is used as an example. The third ring is formed by alternately combining a plurality of first code element patterns and a plurality of second code element patterns, which visually form a “dashed” circle. Different code element patterns correspond to different binary elements (1 or 0).

In an optional embodiment, in order to adapt to data to be encoded with different information quantities, step S202 may include: determining the two-dimensional bar code version based on an information quantity of the data to be encoded; wherein different two-dimensional bar code versions are corresponding to a plurality of valid data bits with different quantities. A large quantity of the plurality of valid data bits indicates a large quantity of loadable information.

In an optional embodiment, in order to facilitate encoding and accuracy of encoding, the encoding method further includes:
combining valid data bits of a single ring into one data segment based on a preset clock direction, so as to obtain a plurality of data segments of the plurality of rings.

In an optional embodiment, in order to facilitate encoding and division of encoded data, the encoding method further includes: determining a sequence of the plurality of data segments according to a sequence from an innermost ring to an outermost ring of the plurality of rings.

In an optional embodiment, the method further includes:
configuring a plurality of locators on an edge of the two-dimensional bar code to be generated, wherein the plurality of locators are distributed on the outermost ring of the plurality of rings. With continued reference to FIG. 3, a circle on the edge of the circular two-dimensional bar code is correspondingly a locator. Each circle represents one locator. It should be noted that the locator is not limited to the four locators shown in FIG. 3, and may be more or less, and may be set according to an actual requirement. A shape of the locator is not limited to a circle shown in the figure, but may be a rectangle or the like. An arrangement manner of the locator is not limited to the arrangement manner shown in FIG. 3, but may be set according to the actual requirement. In the embodiment, the plurality of locators are used to position the circular two-dimensional bar code to improve accuracy and efficiency of recognition. It should be noted that the locator in the embodiment is preferably in a shape of a circle. Because the circular two-dimensional bar code is used in the embodiment, a circular shape can not only improve accuracy of recognition, but also reduce area occupation, thereby minimizing impact on a quantity capacity of the circular two-dimensional bar code. Further, in order to improve efficiency and accuracy of positioning and recognizing of the circular two-dimensional bar code, a quantity of the plurality of locators is four, which are distributed directly above, directly below, directly to the left, and directly to the right of a target center point.

In an optional embodiment, the method further includes:
determining data bits occupied by the plurality of locators as invalid data bits, wherein the invalid data bits are not used to load information. To ensure correctness of valid encoded data, the circular two-dimensional bar code is set as follows: A data bit at an intersection occupied by the plurality of locators is an invalid data bit, and is not used to load valid encoded data. As shown in FIG. 3, data bits at intersections of straight lines #1, #9, #10, #11, #18, #19, #20, #27, #28, #29 and a fifth ring, as well as data bits at intersections of straight lines #1, #9, #10, #11, #18, #19, #20, #27, #28, #29 and a sixth ring are occupied or affected by the locators. To ensure correct encoding, valid data bits of each of the ten straight lines are set to 4 bits, and 2 data bits corresponding to the intersections of each of the ten straight lines and the fifth ring as well as the sixth ring are excluded. It should be noted that, if there is another factor affecting a pattern of data bits in the circular two-dimensional bar code, corresponding excluding needs to be performed.

In an optional embodiment, in order to provide a platform identify and the like of the circular two-dimensional bar code, the encoding method further includes: generating a target pattern within the innermost ring of the plurality of rings, wherein the target pattern includes an identity.

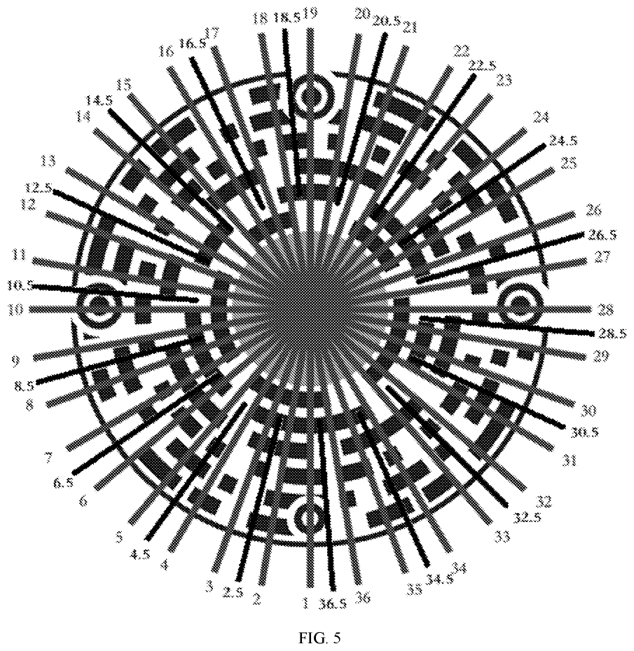

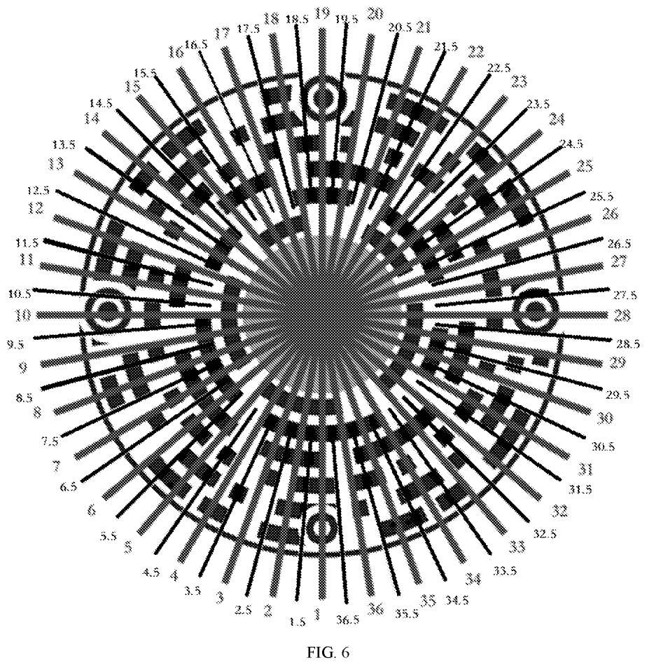

For example, FIG. 3, FIG. 5, and FIG. 6 separately provide different two-dimensional bar code versions.

To make the embodiment easier to understand, a circular two-dimensional bar code (V1 version) provided in the embodiment is described.

As shown in FIG. 3, each ring in the circular two-dimensional bar code has 36 valid data bits for encoding and decoding. A lower half of a straight line perpendicular to a horizontal diameter is numbered #1, and a straight line is added for each offset of 10°, until there are 36 lines arranged in sequence. It should be noted that the straight line in the figure is for the convenience of indicating data bits, and the straight line does not actually exist.

Each straight line can hit a maximum of 6 rings (circular encoding regions):
If an intersection of a straight line and a ring is blank, it represents a data bit 0;
If an intersection of a straight line and a ring is not blank, it represents a data bit 1;
In order to avoid locators and an icon region,
the 10 straight lines #1, #9, #10, #11, #18, #19, #20, #27, #28 and #29 each have 4 valid bits (outer 2 bits are excluded).

Therefore, a maximum quantity of bits supported by the circular two-dimensional bar code may be calculated as follows: (36*6)−(10*2)=196 bits.

In addition, the first 16 bits in an innermost ring may be set as a reserved field. Therefore, bits for valid data storage are: 196−16=180 bits.

As shown in FIG. 4, the foregoing 16 data bits are defined as follows:
(1) A parity bit is used for parity check of a 16-bit reserved field, and may use even parity.
(2) A version number of a two-dimensional bar code may be represented by a binary 0b001-0b011.
(3) An encoding mapping table version may be represented by a binary 0b0001-0b0011.
(4) A data type is in a reserved status, which may be used to identify a type of final decoded data (for example, mid and app-id, 8 definitions are supported in total).
(5) A mask index is in a reserved status, is used to index a decoding mask for a data encoding region, and supports 8 types of decoding masks.
(6) A level of error correction corresponds to definitions of four levels of error correction L, M, Q, and H, which may be represented by a binary 0b00-0b11.

A processing design of an error correcting code (ECC) processing design is as follows:
A level of error correction of the circular two-dimensional bar code is identified by using the last two data bits in the reserved field, and an algorithm of error correction may be consistent with that of QR. For example,
1. Algorithm: GF (256) RS codes;
2. Level: L (0b00), M (0b01), Q (0b10), H (0b11);
3. Storage position of check bit: a very end of the data encoding region.

Note: The check bit is generated for all data regions except the check bit, which does not include the 16-bit reserved field. When data bits cannot be aligned in accordance with 1 byte, the last misaligned data bit is stored in a lower bit with a single 1 byte to generate the check bit.

As shown in Table 1, the level of error correction is defined as follows:

TABLE 1

| | | | | | Error |
|---|---|---|---|---|---|
| Two-dimensional | Level of error | Length of | Length of | | correction |
| bar code version | correction | data bits | check bits | Bit rate | rate |
| V1 | L | 180 bits | 6 * 8 = 48 bits | 73.3% | 13.3% |
| V1 | M | 180 bits | 8 * 8 = 64 bits | 64.4% | 17.8% |
| V1 | Q | 180 bits | 10 * 8 = 80 bits | 55.6% | 22.2% |
| V1 | H | 180 bits | 13 * 8 = 104 bits | 42.2% | 28.9% |

With reference to FIG. 5, a circular two-dimensional bar code (V2 version) provided in the embodiment is described.

Based on the circular two-dimensional bar code (V1 version) provided in FIG. 3, the circular two-dimensional bar code (V2 version) in FIG. 5 adds 18 straight lines in the data region. That is, the circular two-dimensional bar code in FIG. 5 has 54 straight lines.

Valid data bits of each straight line are outer 5 rings, based on the following two considerations.
1. If data of an innermost ring is used too intensively, dirty data is easily generated during encoding and decoding.
2. The innermost ring stores the reserved field that defines element data of the two-dimensional bar code, which requires no version difference (the decoding modes of all versions are the same).

The 18 newly-added straight lines are each between original two straight lines, for example, a straight line #2.5 is between a straight line #2 and a straight line #3 (the straight line #2.5 is offset by 5° in a clockwise direction from the straight line #2). The newly-added straight lines are all located after even-numbered straight lines of the circular two-dimensional bar code in V1 version, that is, new straight lines 2.5, 4.5, 6.5, 8.5, 10.5 . . . are provided after straight lines 2, 4, 6, 8, 10 . . . , respectively.

In order to avoid locators and a platform icon region, valid bits of the four straight lines 10.5, 18.5, 28.5, and 36.5 are 3 bits (outer 2 bits are excluded).

Compared with the circular two-dimensional bar code in V1 version, the circular two-dimensional bar code (V2 version) in FIG. 4 supports the following bits: (18*5) to (4*2)=82 bits. Bits for valid data storage of the circular two-dimensional bar code (V2 version) are: 180+82=262 bits.

A level of error correction of the circular two-dimensional bar code (V2 version) is defined as Table 2 below.

TABLE 2

| | | | | | Error |
|---|---|---|---|---|---|
| Two-dimensional | Level of error | Length of | Length of | | correction |
| bar code version | correction | data bits | check bits | Bit rate | rate |
| V2 | L | 262 bits | 10 * 8 = 80 bits | 69.5% | 15.3% |
| V2 | M | 262 bits | 12 * 8 = 96 bits | 63.4% | 18.3% |
| V2 | Q | 262 bits | 14 * 8 = 112 bits | 57.3% | 21.4% |
| V2 | H | 262 bits | 19 * 8 = 152 bits | 42.0% | 29.0% |

With reference to FIG. 6, a circular two-dimensional bar code (V3 version) provided in the embodiment is described.

Based on the circular two-dimensional bar code (V1 version) provided in FIG. 3, the circular two-dimensional bar code (V3 version) in FIG. 6 adds 36 straight lines in a data region. That is, the circular two-dimensional bar code in FIG. 6 has 72 straight lines.

Valid data bits of each straight line are outer 5 rings, and design considerations are consistent with those in V2 version.

The 18 newly-added straight lines based on V2 version are each between original two straight lines, for example, a straight line #1.5 is between a straight line #1 and a straight line #2 (the straight line #1.5 is offset by 5° rightward from the straight line #1). The newly-added straight lines in V3 version are all located after odd-numbered straight lines of the original straight lines, that is, new straight lines 1.5, 3.5, 5.5, 7.5, 9.5 . . . are provided correspondingly after straight lines 1, 3, 5, 7, 9 . . . . In order to avoid the locators and the platform icon region, valid data bits of the four straight lines 1.5, 9.5, 19.5, and 27.5 are 3 bits (outer 2 bits are excluded).

Compared with the circular two-dimensional bar code in V2 version, the circular two-dimensional bar code (V3 version) in FIG. 6 supports the following bits: (18*5) to (4*2)=82 bits. Bits for valid data storage of the circular two-dimensional bar code (V3 version) are: 262+82=344 bits.

A level of error correction of the circular two-dimensional bar code (V3 version) is defined as Table 3 below.

TABLE 3

| | | | | | Error |
|---|---|---|---|---|---|
| Two-dimensional | Level of error | Length of | Length of check | Bit | correction |
| bar code version | correction | data bits | bits | rate | rate |
| V3 | L | 344 bits | 14 * 8 = 112 bits | 67.4% | 16.3% |
| V3 | M | 344 bits | 16 * 8 = 128 bits | 62.8% | 18.6% |
| V3 | Q | 344 bits | 18 * 8 = 144 bits | 58.1% | 20.9% |
| V3 | H | 344 bits | 23 * 8 = 184 bits | 46.5% | 26.7% |

It can be learned from Table 1, Table 2, and Table 3 that circular two-dimensional bar codes of different versions carry different quantities of data and levels of error correction. Therefore, circular two-dimensional bar codes of different versions may be selected according to a quantity of data to be encoded, a level of error correction, and the like.

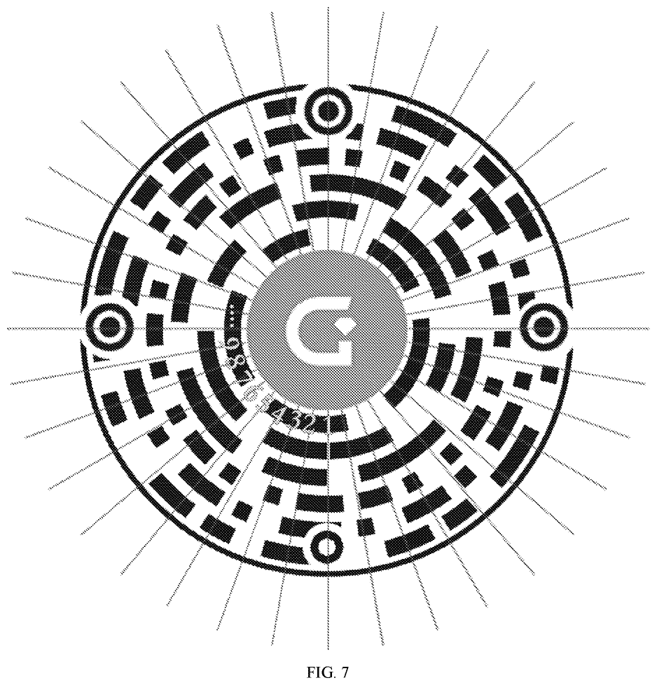

It may be learned from the three two-dimensional bar code versions described above that different versions correspond to different quantities of valid data bits. The following describes an encoding process by using the two-dimensional bar code version shown in FIG. 7 as an example. FIG. 7 shows 36 valid data bits corresponding to each ring provided. Positions of the 36 valid data bits may be on 36 straight lines. It should be noted that the 36 straight lines are only provided for convenience of understanding, and do not exist in an actual two-dimensional bar code. A preset encoding rule is as follows: A straight line directly below a center is a first straight line #1, and a straight line offset by 10° in a clockwise direction is a second straight line #2. By analogy, a 36th straight line #36 is obtained.

An intersection of the first straight line #1 and the first ring (an innermost ring) is taken as a starting encoding position (the first valid data bit). An intersection of the second straight line #2 and the first ring (the innermost ring) is taken as the second valid data bit. By analogy, an intersection of the 36th straight line #36 and the first ring (the innermost ring) is taken as the 36th valid data bit.

Next, an intersection of the first straight line #1 and the second ring (a second innermost ring) is taken as the starting encoding position (the 37th valid data bit). An intersection of the second straight line #2 and the second ring (the second innermost ring) is taken as a 38th valid data bit. By analogy, an intersection of the 36th straight line #36 and the second ring (the second innermost ring) is taken as the 72nd valid data bit.

Then, intersections of the first to 36th straight lines and the third ring correspond to the 73rd to 108th valid data bits, respectively.

Subsequently, intersections of the first to 36th straight lines and the fourth ring correspond to the 109th to 144th valid data bits, respectively.

In the fifth ring, because intersections of the ten straight lines #1, #9, #10, #11, #18, #19, #20, #27, #28, and #29 and the fifth ring (a second innermost ring) are all occupied by placeholders, the intersections are not used for encoding.

Next, an intersection of the second straight line #2 and the fifth ring (the second outermost ring) is the 145th valid data bit. By analogy, twenty-six valid data bits formed by the fifth ring and twenty-six straight lines (in the clockwise direction) are obtained.

In the sixth ring, because intersections of the ten straight lines #1, #9, #10, #11, #18, #19, #20, #27, #28, and #29 and the sixth ring (an outermost ring) are all occupied by placeholders, the intersections are not used for encoding.

Next, an intersection of the second straight line #2 and the sixth ring (the outermost ring) is the 161st data bit. By analogy, twenty-six valid data bits formed by the sixth ring and twenty-six straight lines (in the clockwise direction) are obtained.

It may be learned from the foregoing description that the circular two-dimensional bar code shown in FIG. 7 has 196 data bits.

### Case 1:

The first data bit to the sixteenth valid data bit serve as a reserved field. With the seventeenth valid data bit as a starting position, binary data can be sequentially filled at corresponding positions (intersections). If binary data filled at a position is a first value (for example, “0”), a first code element pattern (for example, white) is formed at the position. If binary data filled at a position is a second value (for example, “1”), a second code element pattern (for example, black) is formed at the position. In the foregoing manner, a circular two-dimensional bar code corresponding to binary data may be formed.

### Case 2:

With the first valid data bit as a starting position, binary data can be sequentially filled at corresponding positions (intersections). If binary data filled at a position is the first value (for example, “0”), the first code element pattern (for example, white) is formed at the position. If binary data filled at a position is the second value (for example, “1”), the second code element pattern (for example, black) is formed at the position. In the foregoing manner, a circular two-dimensional bar code corresponding to binary data may be formed. It should be noted that the first or second code element pattern can be randomly generated at a non-intersecting position on a ring. If the binary data is less than 196 bits, specific black and white regions may be formed at the end.

It should be noted that for the 196 data bits, which data bits are used to load encoded data, and which data bits are used for other purposes may be set according to an actual requirement. The foregoing two cases are not intended to limit the patent protection scope.

Different from a case in which black and white code elements are used as valid encoded data of a two-dimensional bar code, in the embodiment, valid encoded data on each ring is determined by first determining valid data bits and invalid data bits. Therefore, the circular two-dimensional bar code requires specific encoding and decoding modes. In the context of privacy and showcasing brand personality, a highly recognizable and private special-shaped (circular) two-dimensional bar code is provided, which has secure data content, and is applicable to dedicated use in a specific scenario.

### Embodiment 2

A decoding method in the embodiment is corresponding to the encoding method in Embodiment 1. For specific details, refer to Embodiment 1.

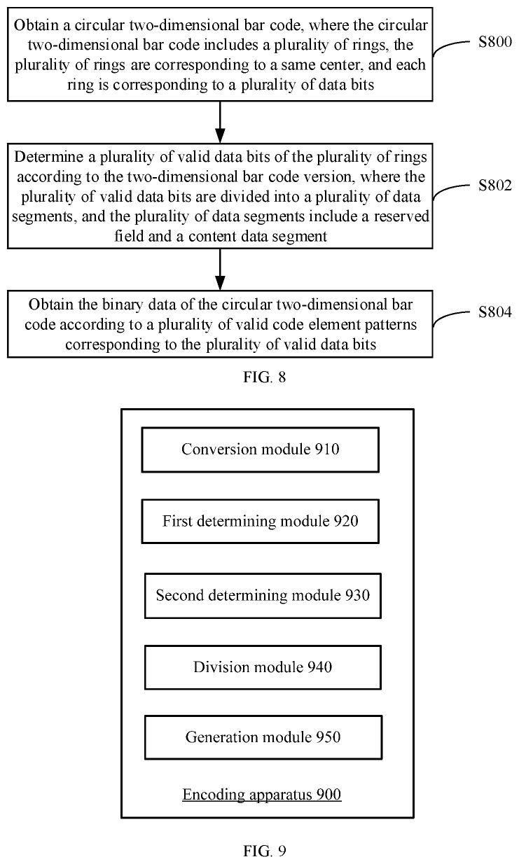

FIG. 8 is a schematic flowchart of a decoding method for a circular two-dimensional bar code according to Embodiment 2 of the application. As shown in FIG. 8, the decoding method for a circular two-dimensional bar code may include steps S800~S804.
Step S800: Obtain a circular two-dimensional bar code, wherein the circular two-dimensional bar code includes a plurality of rings, the plurality of rings are corresponding to a same center, and each ring is corresponding to a plurality of data bits.
Step S802: Determine a plurality of valid data bits of the plurality of rings according to a two-dimensional bar code version, wherein the plurality of valid data bits are divided into a plurality of data segments, the plurality of data segments include a reserved field and a content data segment, the reserved field is used to store metadata, and the content data segment is used to store binary data.
Step S804: Obtain binary data of the circular two-dimensional bar code according to a plurality of valid code element patterns corresponding to the plurality of valid data bits.

In an optional embodiment, the method further includes:
determining valid data bits of a single ring as one data segment based on a preset clock direction, so as to obtain a plurality of data segments of the plurality of rings; and
determining a sequence of the plurality of data segments according to a sequence from an innermost ring to an outermost ring of the plurality of rings.

### Embodiment 3

FIG. 9 is a schematic block diagram of an encoding system for a circular two-dimensional bar code according to Embodiment 3 of the application. The encoding system for a circular two-dimensional bar code may be divided into one or more program modules. The one or more program modules are stored in a storage medium, and are executed by one or more processors, so as to complete the embodiment of the application. The program modules in the embodiment of the application is a series of computer-readable instruction segments that can complete a specific function. The following specifically describes a function of each program module in the embodiment. As shown in FIG. 9, the encoding system 900 for a circular two-dimensional bar code may include a conversion module 910, a first determining module 920, a second determining module 930, a division module 940, and a generation module 950.

The conversion module 910 is configured to convert data to be encoded into binary data.

The first determining module 920 is configured to determine a two-dimensional bar code version of a two-dimensional bar code to be generated, wherein the two-dimensional bar code to be generated includes a plurality of rings corresponding to a same center, and each ring is corresponding to a plurality of data bits.

The second determining module 930 is configured to determine a plurality of valid data bits of the plurality of rings according to the two-dimensional bar code version.

The division module 940 is configured to divide the plurality of valid data bits into a plurality of data segments, wherein the plurality of data segments include a reserved field and a content data segment, the reserved field is used to encode metadata, and the content data segment is used to encode the binary data.

The generation module 950 is configured to generate corresponding code element patterns at the plurality of valid data bits according to the metadata and the binary data, so as to obtain the circular two-dimensional bar code.

In an optional embodiment, the second determining module 930 is further configured to:
determine the two-dimensional bar code version based on an information quantity of the data to be encoded,
wherein different two-dimensional bar code versions are corresponding to a plurality of valid data bits with different quantities.

In an optional embodiment, the system further includes a combination module, configured to: combine valid data bits of a single ring into one data segment based on a preset clock direction, so as to obtain a plurality of data segments of the plurality of rings.

In an optional embodiment, the system further includes a third determining module, configured to:
determine a sequence of the plurality of data segments according to a sequence from an innermost ring to an outermost ring of the plurality of rings.

In an optional embodiment, the system further includes a configuration module, configured to:
configure a plurality of locators on an edge of the two-dimensional bar code to be generated, where the plurality of locators are distributed on the outermost ring of the plurality of rings.

In an optional embodiment, the system further includes a fourth determining module, configured to:
determine data bits occupied by the plurality of locators as invalid data bits, wherein the invalid data bits are not used to load information.

In an optional embodiment, the generation module is further configured to:
generate a target pattern within the innermost ring of the plurality of rings, wherein the target pattern includes an identity.

### Embodiment 4

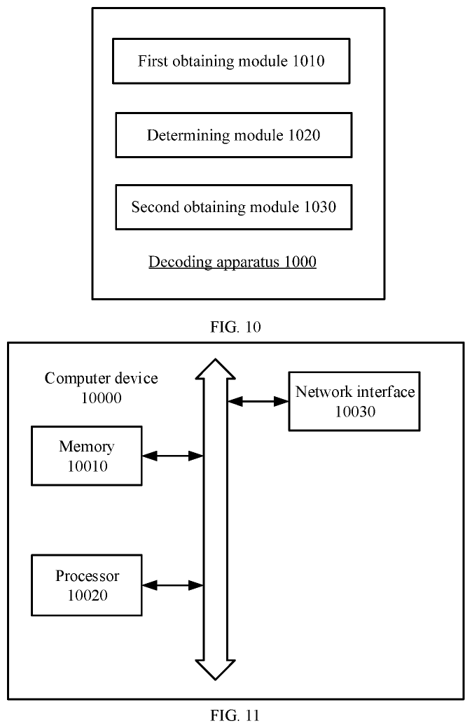

FIG. 10 is a schematic block diagram of a decoding system for a circular two-dimensional bar code according to Embodiment 4 of the application. The decoding system for a circular two-dimensional bar code may be divided into one or more program module. The one or more program modules are stored in a storage medium, and are executed by one or more processors, to complete the embodiment of the application. The program modules in the embodiment of the application are a series of computer-readable instruction segments that can complete a specific function. The following specifically describes a function of each program module in the embodiment. As shown in FIG. 10, the decoding system 1000 for a circular two-dimensional bar code may include a first obtaining module 1010, a first determining module 1020, and a second obtaining module 1030.

The first obtaining module 1010 is configured to obtain a circular two-dimensional bar code, wherein the circular two-dimensional bar code includes a plurality of rings, the plurality of rings are corresponding to a same center, and each ring is corresponding to a plurality of data bits.

The determining module 1020 is configured to determine a plurality of valid data bits of the plurality of rings according to a two-dimensional bar code version, wherein the plurality of valid data bits are divided into a plurality of data segments, the plurality of data segments include a reserved field and a content data segment, the reserved field is used to store metadata, and the content data segment is used to store binary data.

The second obtaining module 1030 is configured to obtain binary data of the circular two-dimensional bar code according to a plurality of valid code element patterns corresponding to the plurality of valid data bits.

In an optional embodiment, the system further includes a third determining module, configured to:
determine valid data bits of a single ring as one data segment based on a preset clock direction, so as to obtain a plurality of data segments of the plurality of rings; and
determine a sequence of the plurality of data segments according to a sequence from an innermost ring to an outermost ring of the plurality of rings.

### Embodiment 5

FIG. 11 is a schematic diagram of a hardware architecture of a computer device suitable for implementing an encoding/decoding method for a circular two-dimensional bar code according to Embodiment 5 of the application. A computer device 10000 may be used as an encoding device 2 for a two-dimensional bar code or a decoding device 4 for a two-dimensional bar code, or a part thereof. The computer device 10000 is a device that can automatically calculate a value and/or process information based on an instruction that is set or stored in advance. For example, the computer device may be a smartphone, a tablet computer, a computer, an in-vehicle terminal, a game machine, a virtual device, a scanner, or the like, or may be a server.

In the embodiment, the computer device 10000 is a device that can automatically calculate a value and/or process information based on an instruction that is set or stored in advance. As shown in FIG. 11, the computer device 10000 at least includes but is not limited to a memory 10010, a processor 10020, and a network interface 10030 that can be communicatively connected to each other by using a system bus.

The memory 10010 includes at least one type of computer-readable storage medium. The readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, or the like. In some embodiments, the memory 10010 may be an internal storage module of the computer device 10000, for example, a hard disk or an internal memory of the computer device 10000. In some other embodiments, the memory 10010 may be an external storage device of the computer device 10000, for example, a removable hard disk, a smart media card (SMC), a secure digital (SD) card, or a flash card that is disposed on the computer device 10000. Certainly, the memory 10010 may alternatively include both an internal storage module of the computer device 10000 and an external storage device of the computer device 10000. In the embodiment, the memory 10010 is usually configured to store an operating system and various types of application software that are installed on the computer device 10000, for example, program code of an encoding method for a circular two-dimensional bar code. In addition, the memory 10010 may be further configured to temporarily store various types of data that have been output or are to be output.

The processor 10020 may be a central processing unit (CPU), a controller, a microcontroller, a microprocessor, or another data processing chip in some embodiments. The processor 10020 is usually configured to control an overall operation of the computer device 10000, for example, perform control and processing related to data exchange or communication performed by the computer device 10000. In the embodiment, the processor 10020 is configured to run program code stored in the memory 10010 or process data.

The network interface 10030 may include a wireless network interface or a wired network interface, and the network interface 10030 is usually configured to establish a communication link between the computer device 10000 and another computer device. For example, the network interface 10030 is configured to: connect the computer device 10000 to an external terminal by using a network, and establish a data transmission channel, a communication link, and the like between the computer device 10000 and the external terminal. The network may be a wireless or wired network, for example, an Intranet, the Internet, a global system for mobile communications (GSM), a wideband code division multiple access (WCDMA), a 4G network, a 5G network, Bluetooth, or Wi-Fi.

It should be noted that FIG. 11 shows only a computer device with the components 10010 to 10030. However, it should be understood that implementation of all the shown components is not required, and more or fewer components may alternatively be implemented.

In the embodiment, the encoding method and the decoding method for a circular two-dimensional bar code stored in the memory 10010 may be further divided into one or more program modules to be executed by one or more processors (the processor 10020 in the embodiment), so as to complete the application.

### Embodiment 6

The embodiment further provides a computer-readable storage medium. The computer-readable storage medium stores computer-readable instructions. The computer-readable instructions are executed by a processor to implement the steps of the encoding method and the decoding method for a circular two-dimensional bar code.

In the embodiment, the computer-readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, or the like. In some embodiments, the computer-readable storage medium may be an internal storage unit of a computer device, for example, a hard disk or an internal memory of the computer device. In some other embodiments, the computer-readable storage medium may be an external storage device of the computer device, for example, a removable hard disk, a smart media card (SMC), a secure digital (SD) card, or a flash card that is disposed on the computer device. Certainly, the computer-readable storage medium may alternatively include both an internal storage unit of the computer device and an external storage device of the computer device. In the embodiment, the computer-readable storage medium is usually configured to store an operating system and various types of application software that are installed on the computer device, for example, program code of the encoding method for a circular two-dimensional bar code in the embodiments. In addition, the computer-readable storage medium may be further configured to temporarily store various types of data that have been output or are to be output.

Clearly, a person skilled in the art should understand that the foregoing modules or steps in the embodiments of the application may be implemented by using a general computing apparatus. The modules or steps may be integrated into a single computing apparatus or distributed in a network including a plurality of computing apparatuses. Optionally, the modules or steps may be implemented by using program code that can be executed by the computing apparatus. Therefore, the modules or steps may be stored in a storage apparatus for execution by the computing apparatus. In addition, in some cases, the shown or described steps may be performed in a sequence different from the sequence herein. Alternatively, the modules or steps may be separately made into integrated circuit modules, or a plurality of modules or steps in the modules or steps may be made into a single integrated circuit means for implementation. In this way, a combination of any specific hardware and software is not limited in the embodiments of the application.

It should be noted that the foregoing descriptions are merely preferred embodiments of the application, and are not intended to limit the patent protection scope of the application. Any equivalent structure or equivalent procedure change made based on the content of this specification and the accompanying drawings of the application is directly or indirectly applied to other related technical fields, and shall fall within the patent protection scope of the application.

1. An encoding method for a circular two-dimensional bar code, comprising:
converting data to be encoded into binary data;
determining a two-dimensional bar code version of a two-dimensional bar code to be generated, wherein the two-dimensional bar code to be generated comprises a plurality of rings corresponding to a same center, and each ring is corresponding to a plurality of data bits;
determining a plurality of valid data bits of the plurality of rings according to the two-dimensional bar code version;
dividing the plurality of valid data bits into a plurality of data segments, wherein the plurality of data segments comprise a reserved field and a content data segment, the reserved field is used to encode metadata, and the content data segment is used to encode the binary data; and
generating corresponding code element patterns at the plurality of valid data bits according to the metadata and the binary data, so as to obtain the circular two-dimensional bar code.

2. The encoding method for a circular two-dimensional bar code according to claim 1, wherein the determining a two-dimensional bar code version of a two-dimensional bar code to be generated comprises:
determining the two-dimensional bar code version based on an information quantity of the data to be encoded;
wherein different two-dimensional bar code versions are corresponding to a plurality of valid data bits with different quantities.

3. The encoding method for a circular two-dimensional bar code according to according to claim 1, further comprising:
combining valid data bits of a single ring into one data segment based on a preset clock direction, so as to obtain a plurality of data segments of the plurality of rings.

4. The encoding method for a circular two-dimensional bar code according to according to claim 1, further comprising:
determining a sequence of the plurality of data segments according to a sequence from an innermost ring to an outermost ring of the plurality of rings.

5. The encoding method for a circular two-dimensional bar code according to claim 1, further comprising:
configuring a plurality of locators on an edge of the two-dimensional bar code to be generated, wherein the plurality of locators are distributed on the outermost ring of the plurality of rings.

6. The encoding method for a circular two-dimensional bar code according to claim 5, further comprising:
determining data bits occupied by the plurality of locators as invalid data bits, wherein the invalid data bits are not used to load information.

7. The encoding method for a circular two-dimensional bar code according to claim 4, further comprising:
generating a target pattern within the innermost ring of the plurality of rings, wherein the target pattern comprises an identity.

8. An encoding system for a circular two-dimensional bar code, comprising:
a conversion module, configured to convert data to be encoded into binary data;
a first determining module, configured to determine a two-dimensional bar code version of a two-dimensional bar code to be generated, wherein the two-dimensional bar code to be generated comprises a plurality of rings corresponding to a same center, and each ring is corresponding to a plurality of data bits;
a second determining module, configured to determine a plurality of valid data bits of the plurality of rings according to the two-dimensional bar code version;
a division module, configured to divide the plurality of valid data bits into a plurality of data segments, wherein the plurality of data segments comprise a reserved field and a content data segment, the reserved field is used to encode metadata, and the content data segment is used to encode the binary data; and
a generation module, configured to generate corresponding code element patterns at the plurality of valid data bits according to the metadata and the binary data, so as to obtain the circular two-dimensional bar code.

9. The encoding system for a circular two-dimensional bar code according to according to claim 8, wherein the first determining module is further configured to:
determine the two-dimensional bar code version based on an information quantity of the data to be encoded;
wherein different two-dimensional bar code versions are corresponding to a plurality of valid data bits with different quantities.

10. The encoding system for a circular two-dimensional bar code according to claim 8, wherein the encoding system further comprises a combination module, configured to:
combine valid data bits of a single ring into one data segment based on a preset clock direction, so as to obtain a plurality of data segments of the plurality of rings.

11. The encoding system for a circular two-dimensional bar code according to claim 8, wherein the encoding system further comprises a third determining module, configured to:
determine a sequence of the plurality of data segments according to a sequence from an innermost ring to an outermost ring of the plurality of rings.

12. The encoding system for a circular two-dimensional bar code according to claim 8, wherein the encoding system further comprises a configuration module, configured to:
configure a plurality of locators on an edge of the two-dimensional bar code to be generated, wherein the plurality of locators are distributed on the outermost ring of the plurality of rings.

13. The encoding system for a circular two-dimensional bar code according to claim 12, wherein the encoding system further comprises a fourth determining module, configured to:
determine data bits occupied by the plurality of locators as invalid data bits, wherein the invalid data bits are not used to load information.

14. The encoding system for a circular two-dimensional bar code according to claim 8, wherein the generation module is further configured to:
generate a target pattern within the innermost ring of the plurality of rings, wherein the target pattern comprises an identity.

15. A decoding method for a circular two-dimensional bar code, comprising:
obtaining a circular two-dimensional bar code, wherein the circular two-dimensional bar code comprises a plurality of rings, the plurality of rings are corresponding to a same center, and each ring is corresponding to a plurality of data bits;
determining a plurality of valid data bits of the plurality of rings according to a two-dimensional bar code version of the circular two-dimensional bar code, wherein the plurality of valid data bits are divided into a plurality of data segments, the plurality of data segments comprise a reserved field and a content data segment, the reserved field is used to store metadata, and the content data segment is used to store binary data; and
obtaining binary data of the circular two-dimensional bar code according to a plurality of valid code element patterns corresponding to the plurality of valid data bits.

16. The decoding method for a circular two-dimensional bar code according to claim 15, further comprising:
determining valid data bits of a single ring as one data segment based on a preset clock direction, so as to obtain a plurality of data segments of the plurality of rings; and
determining a sequence of the plurality of data segments according to a sequence from an innermost ring to an outermost ring of the plurality of rings.

17. A decoding system for a circular two-dimensional bar code, comprising:
a first obtaining module, configured to obtain a circular two-dimensional bar code, wherein the circular two-dimensional bar code comprises a plurality of rings, the plurality of rings are corresponding to a same center, and each ring is corresponding to a plurality of data bits;
a determining module, configured to determine a plurality of valid data bits of the plurality of rings according to a two-dimensional bar code version of the circular two-dimensional bar code, wherein the plurality of valid data bits are divided into a plurality of data segments, the plurality of data segments comprise a reserved field and a content data segment, the reserved field is used to store metadata, and the content data segment is used to store binary data; and
a second obtaining module, configured to obtain binary data of the circular two-dimensional bar code according to a plurality of valid code element patterns corresponding to the plurality of valid data bits.

18. The decoding system for a circular two-dimensional bar code according to claim 17, wherein the decoding system further comprises a third determining module, configured to:
determine valid data bits of a single ring as one data segment based on a preset clock direction, so as to obtain a plurality of data segments of the plurality of rings; and
determine a sequence of the plurality of data segments according to a sequence from an innermost ring to an outermost ring of the plurality of rings.

19. A computer device, comprising a memory, a processor, and computer-readable instructions that are stored in the memory and that are capable of running on the processor, wherein when executing the computer-readable instructions, the processor implements:
steps:
converting data to be encoded into binary data;
determining a two-dimensional bar code version of a two-dimensional bar code to be generated, wherein the two-dimensional bar code to be generated comprises a plurality of rings corresponding to a same center, and each ring is corresponding to a plurality of data bits;
determining a plurality of valid data bits of the plurality of rings according to the two-dimensional bar code version;
dividing the plurality of valid data bits into a plurality of data segments, wherein the plurality of data segments comprise a reserved field and a content data segment, the reserved field is used to encode metadata, and the content data segment is used to encode the binary data; and
generating corresponding code element patterns at the plurality of valid data bits according to the metadata and the binary data, so as to obtain the circular two-dimensional bar code;
and/or steps:
obtaining a circular two-dimensional bar code, wherein the circular two-dimensional bar code comprises a plurality of rings, the plurality of rings are corresponding to a same center, and each ring is corresponding to a plurality of data bits;
determining a plurality of valid data bits of the plurality of rings according to a two-dimensional bar code version of the circular two-dimensional bar code, wherein the plurality of valid data bits are divided into a plurality of data segments, the plurality of data segments comprise a reserved field and a content data segment, the reserved field is used to store metadata, and the content data segment is used to store binary data; and
obtaining binary data of the circular two-dimensional bar code according to a plurality of valid code element patterns corresponding to the plurality of valid data bits.

20. A non-transitory computer-readable storage medium, wherein the computer-readable storage medium stores computer-readable instructions, and the computer-readable instructions are capable of being executed by at least one processor to enable the at least one processor to perform:
steps:
converting data to be encoded into binary data;
determining a two-dimensional bar code version of a two-dimensional bar code to be generated, wherein the two-dimensional bar code to be generated comprises a plurality of rings corresponding to a same center, and each ring is corresponding to a plurality of data bits;
determining a plurality of valid data bits of the plurality of rings according to the two-dimensional bar code version;
dividing the plurality of valid data bits into a plurality of data segments, wherein the plurality of data segments comprise a reserved field and a content data segment, the reserved field is used to encode metadata, and the content data segment is used to encode the binary data; and
generating corresponding code element patterns at the plurality of valid data bits according to the metadata and the binary data, so as to obtain the circular two-dimensional bar code;
and/or steps:
obtaining a circular two-dimensional bar code, wherein the circular two-dimensional bar code comprises a plurality of rings, the plurality of rings are corresponding to a same center, and each ring is corresponding to a plurality of data bits;
determining a plurality of valid data bits of the plurality of rings according to a two-dimensional bar code version of the circular two-dimensional bar code, wherein the plurality of valid data bits are divided into a plurality of data segments, the plurality of data segments comprise a reserved field and a content data segment, the reserved field is used to store metadata, and the content data segment is used to store binary data; and
obtaining binary data of the circular two-dimensional bar code according to a plurality of valid code element patterns corresponding to the plurality of valid data bits.
